(19) United States
(12) Patent Application Publication
(10) Pub. No.: US 2025/0216828 A1
(43) Pub. Date: Jul. 3, 2025

(54) SYSTEMS AND METHODS FOR CONSTRAINT ENFORCEMENT IN EVENT STREAMS

(71) Applicant: Discover Financial Services, Riverwoods, IL (US)

(72) Inventors: Alok Dwivedi, Reading (GB); Duncan Stewart, London (GB)

(21) Appl. No.: 18/400,528

(22) Filed: Dec. 29, 2023

(51) Int. Cl. G05B 19/042

(52) U.S. Cl. CPC G05B 19/042; G05B 2219/25011

(57) ABSTRACT

A computing system is configured to (i) receive an event stream produced by at least one event producer; (ii) evaluate each respective event in the event stream against a set of one or more constraints; (iii) based on the evaluation, determine that a given event in the event stream is governed by a given constraint in the set of one or more constraints; (iv) after determining that the given event is governed by the given constraint, cause the event to be replaced by a corresponding placeholder event within the event stream, wherein the placeholder event omits at least a portion of data included within the given event; and (v) after determining that the given event is governed by the given constraint, cause the given event to be stored in an event repository that complies with the given constraint.

### BACKGROUND

Entities often rely on event-driven architectures to publish events that are subsequently consumed by downstream applications. Entities may use such event-driven architectures to facilitate e-commerce transactions, social media websites, and the management of Internet of Things (IoT) devices. Many other uses of event-driven architectures are possible as well.

### OVERVIEW

Disclosed herein is new technology for implementing a constraint engine in a messaging system that replaces events that contain sensitive data with placeholder events to ensure that an event stream the messaging system provides to downstream consumers complies with legal mandates and network security protocols without compromising the continuity of the event stream and without preventing authorized consumers from accessing the sensitive data.

In one aspect, the disclosed technology may take the form of a method to be carried out by a computing system that involves (i) receiving an event stream produced by at least one event producer; (ii) evaluating each respective event in the event stream against a set of one or more constraints; (iii) based on the evaluation, determining that a given event in the event stream is governed by a given constraint in the set of one or more constraints; (iv) after determining that the given event is governed by the given constraint, causing the event to be replaced by a corresponding placeholder event within the event stream, wherein the placeholder event omits at least a portion of data included within the given event; and (v) after determining that the given event is governed by the given constraint, causing the given event to be stored in an event repository that complies with the given constraint.

In some examples, the method carried out by the computing system further involves: (i) receiving, from a consumer that has subscribed to the event stream, a request for the given event; (ii) validating that the consumer is authorized to access the given event; (iii) retrieving the given event from the data repository; and (iv) transmitting the given event to the consumer in response to the request.

Further, in some examples, validating that the consumer is authorized to access the given event comprises: (i) identifying a location where the consumer is located; (ii) comparing the location to a triggering condition included in the given constraint; and (iii) based on the comparison, determining that transmitting the given event to the consumer would not violate the constraint.

Still further, in some examples, validating that the consumer is authorized to access the given event comprises: (i) identifying an information technology (IT) protocol that is enforced upon the consumer; (ii) comparing the IT protocol to a triggering condition included in the given constraint; and (iii) based on the comparison, determining that transmitting the given event to the consumer would not violate the constraint.

Still further, in some examples, the placeholder event (i) omits at least a portion of an event payload included in the given event; and includes data that identifies that the given event is stored in the data repository.

Still further, in some examples, the method carried out by the computing system further involves, prior to causing the given event to be stored in the event repository: (i) identifying a location where the event repository is located; (ii) comparing the location of the event repository to a triggering condition included in the given constraint; and (iii) based on the comparison, determining that storing the given event in the event repository would not violate the given constraint.

In yet another aspect, disclosed herein is a computing system that includes a network interface for communicating over at least one data network, at least one processor, at least one non-transitory computer-readable medium, and program instructions stored on the at least one non-transitory computer-readable medium that are executable by the at least one processor to cause the computing system to carry out the functions disclosed herein, including but not limited to the functions of one or both of the foregoing methods.

In still another aspect, disclosed herein is a non-transitory computer-readable medium provisioned with program instructions that, when executed by at least one processor, cause a computing system to carry out the functions disclosed herein, including but not limited to the functions of one or both of the foregoing methods.

One of ordinary skill in the art will appreciate these as well as numerous other aspects in reading the following disclosure.

### BRIEF DESCRIPTION OF THE DRAWINGS

FIG. 1 depicts an illustrative example of a computing platform that implements an event-driven architecture.

FIG. 2A shows one illustrative example of a stream of events within an event-driven architecture.

FIG. 2B depicts an illustrative example in which event producers produce events and send those events to a messaging system for inclusion in an event stream.

FIG. 3 depicts an illustrative example of a computing platform that implements an event-driven architecture and incorporates a constraint engine.

FIG. 4 depicts an example process that may be performed in an event-driven architecture for constraint enforcement.

FIG. 5A depicts illustrative examples of a constrained event and a corresponding placeholder event.

FIG. 5B depicts an example scenario in which a computing platform performs processes described herein to illustrate how constrained events and unconstrained events flow through a messaging system in an event stream.

FIG. 6 depicts an example process that may be performed in an event-driven architecture for a consumer to access a copy of an event that was previously replaced by a placeholder event in an event stream.

FIG. 7 depicts an example scenario in which a computing platform performs processes described herein to show how a local copy of an event stream at a consumer will appear after placeholder events are replaced with unmodified copies of corresponding events.

FIG. 8 is a simplified block diagram that illustrates some structural components of an example computing platform that may be configured to perform some or all of the functions discussed herein for constraint enforcement in event streams in accordance with the present disclosure.

Features, aspects, and advantages of the presently disclosed technology may be better understood with regard to the following description, appended claims, and accompanying drawings, as listed below. The drawings are for the purpose of illustrating examples, but those of ordinary skill in the art will understand that the technology disclosed herein is not limited to the arrangements and/or instrumentality shown in the drawings.

### DETAILED DESCRIPTION

Disclosed herein is a new technology that facilitates (i) compliance with constraints imposed on an event stream by legal or data-security concerns in an event stream, (ii) the continuity and sequence of the event stream are not compromised, and (iii) the availability, to authorized consumers, of copies of events to which the constraints apply.

The disclosed technology may be carried out by any entity that engages in producing events, facilitating the delivery of events, and/or consuming events, examples of which include entities that facilitate e-commerce transactions, social media websites, and the management of Internet of Things (IoT) devices, among many other possibilities.

Entities such as these typically employ one or more computing platforms that include, at least in part, an event-driven architecture for producing, facilitating the delivery of, and consuming events. A typical event-driven architecture is made up of a collection of discrete software components, sometimes referred to as “services,” each of which may carry out one or more functions within the event-driven architecture. These software components may be implemented using various different techniques. For example, the software components may be implemented in part using a microservices architecture where one or more of the software components are deployed in containers and communicate using respective application programming interfaces (APIs). As another example, one or more of the software components may utilize a serverless architecture where the given software component is implemented as a set of cloud-based functions that may be run in response to another software component accessing the given software component's API. A computing platform implementing an event-driven architecture may integrate aspects of any of these various techniques, among others, in any combination.

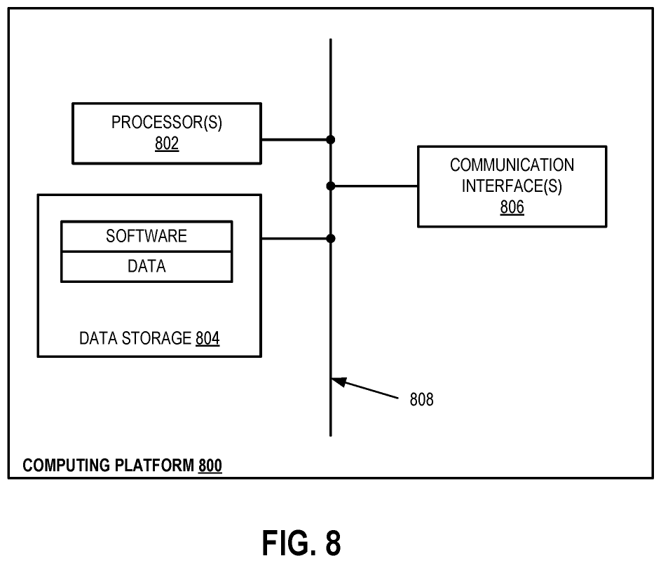

The physical instantiation of the one or more software components discussed above may also take various forms. In this regard, it should be noted that the physical hardware (e.g., servers, processors, communication interfaces, etc.) that performs the functions within the event-driven-architecture might not be organized along the same logical lines as the associated software components. As one example, a given software component may be collectively implemented by two or more physically distinct computing systems within an overall computing platform. As another example, two or more logically separate software components (e.g., within separate containers or virtual machines) may be implemented using the same physical hardware. The software components may take other forms and may be implemented in other ways as well. Some of the structural components of the computing system(s) that might constitute an overall computing platform implementing an event-driven architecture are discussed further below in relation to FIG. 8.

The events that are produced and consumed in an event-driven architecture may take various forms, one of which may include a change in state in the computing platform that implements the event-driven architecture. As one example, if the event-driven architecture facilitates e-commerce transactions, an event may include a purchase order, a product availability inquiry, or an item return, among other possibilities. As another example, if the event-driven architecture facilitates social media interactions across a social media platform, an event may include a notification that a user has posted an update (e.g., a message, a photo, a reaction to another user's post, etc.). As yet another example, if the event-driven architecture facilitates the management of IoT devices, an event may include a temperature sensor reading from a network-connected thermostat or a proximity alert from a network-connected motion detector, among other possibilities.

As noted above, the discrete software components within an event-driven architecture may carry out various different functions. For instance, one or more of the discrete software components may generate events within the event-driven architecture. For purposes of the following discussion, the one or more software components (and the associated physical computing system(s)) that generate events within the event-driven architecture (or that aggregate events into an event stream associated with that event-driven architecture) may generally be referred to as one or more “producers.” A given producer within the event-driven architecture may take various forms. As one example in the context of an e-commerce platform, the given producer may take the form of a point-of-sale device, where the point-of-sale device generates an event for each sale or return. As another example, the given producer may take the form of a mobile application, where the mobile application generates an event in response to receiving an inquiry about the availability of an item for sale. As yet another example, the given producer may take the form of a retail website, where the retail website generates an event in response to a user placing a new order for an item. The given producer may take many other forms as well, depending on the application of the event-driven architecture.

Further, one or more of the discrete software components discussed above may consume the generated events within the event-driven architecture. In this regard, consuming an event may generally refer to receiving the event (e.g., receiving an indication of the event's occurrence), and perhaps performing some processing associated with the event as well. For purposes of the following discussion, the one or more discrete software components (and associated physical computing system(s)) that consume events within the event-driven architecture may be referred to as one or more “consumers.” A given consumer within the event-driven architecture may take various forms. As one example in the context of an e-commerce platform, the given consumer may take the form of a warehouse management database, where the warehouse management database may consume a produced sale event and, in response, update the warehouse management database's inventory and item availability records. As another example, the given consumer may take the form of a finance system, where the finance system may consume a produced sale event (e.g., the same sale event as the previous example) and, in response, update financial records to reflect the sale. As yet another example, the given consumer may take the form of a customer relations system, where the customer relations system may consume an event corresponding to a question about availability of a particular item for sale and, in response, generate a notification for a customer relations expert to respond to the inquiry. The given consumer may take many other forms as well, depending on the application of the event-driven architecture.

Further still, one or more of the discrete software components discussed above may facilitate (i) the delivery of events from the one or more producers to the one or more consumers and (ii) the delivery of one or more responses from the one or more consumers to the one or more producers. These software components may collectively form a messaging system through which events and responses can be sent. Such a messaging system may take various forms. As one possibility, the messaging system may take the form of an event broker that receives, stores, and delivers events from a producer to one or more consumers. As another possibility, the messaging system may take the form of an event router that receives events from a producer and routes them to one or more consumers. As yet another possibility, the messaging system may take the form of a messaging bus that receives produced events from a producer and delivers the produced events to one or more consumers that subscribe to the producer. The messaging system may take other forms as well.

Further, the messaging system may employ a variety of technologies to receive the events from a producer and deliver the events to a consumer. As one possibility, the messaging system may employ one or more queues, where the messaging system receives a produced event and places the received event in a queue that can be accessed by a consumer. As another possibility, the messaging system may employ one or more topics, where the messaging system applies additional metadata to the received event that facilitates the delivery of the event to consumers that have subscribed to the events corresponding to the topic. As yet another possibility, the messaging system may employ one or more logs, where the messaging system stores received events in a log that can be later accessed by a consumer. As still another possibility, the messaging system may employ streams, where the messaging system receives a produced event and makes the event available to the consumer in real time. The messaging system may employ other technologies as well.

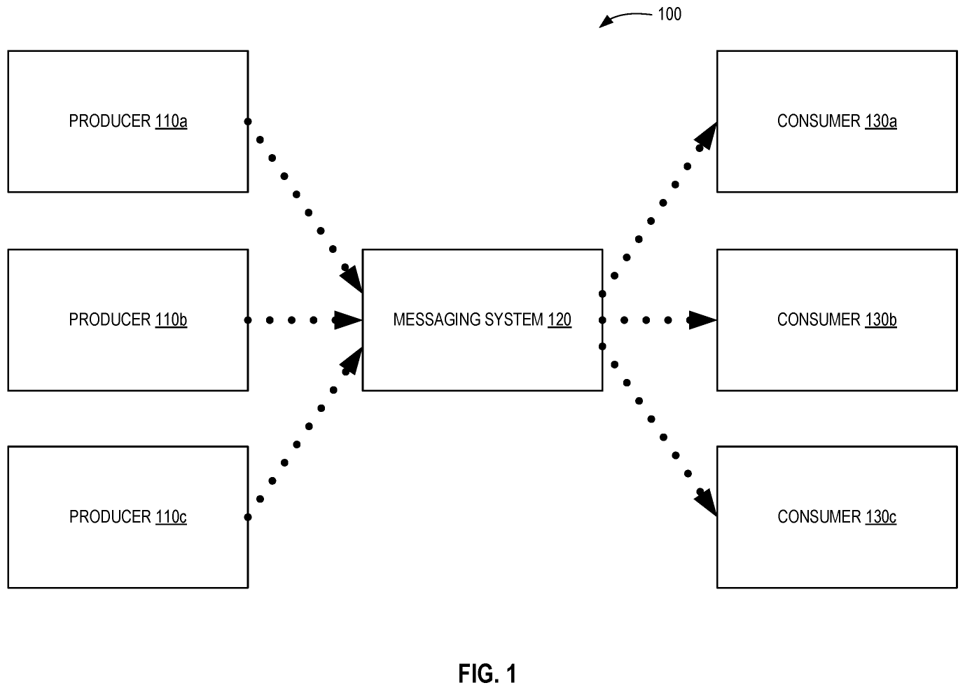

Turning to FIG. 1, an illustrative example of a computing platform 100 implementing an event-driven architecture is shown. The event-driven architecture includes one or more event producers, illustrated by way of example as producer 110a, producer 110b, and producer 110c. The event-driven architecture also includes a messaging system 120 and one or more event consumers, illustrated by way of example as consumer 130a, consumer 130b, and consumer 130c. The event producers may be configured to produce events associated with the computing platform 100 and may take various forms. As one possibility, event producer 110a may be a point-of-sale system that is configured to produce payment transaction events each time an item is purchased. Accordingly, each event may be a data object that includes information about the payment transaction. For instance, each event may be organized according to a schema that defines certain data fields (e.g., a globally unique event identifier (GUID) or a universally unique identifier (UUID), a merchant identity, a payment amount, a transaction date, a transaction time, etc.) and corresponding values for the included data fields. (Note that, in some examples, the GUID or UUID may be a 128-bit integer.)

As another possibility, event producer 110b may be a customer service system that is configured to produce an event each time a dispute related to a payment transaction event is initiated (e.g., each time a business or customer disputes a transaction). Accordingly, each event may be a data object that includes information about the disputed transaction. For instance, a disputed transaction event may include a schema that may define different data fields (e.g., the disputed payment event's globally unique event identifier, a merchant identity, a disputed payment amount, etc.) and corresponding values for those data fields. The event producers, and the associated events they produce, may take many other forms as well.

Each of the producers shown in FIG. 1 may be configured to produce events and send them to the messaging system 120. In this respect, the messaging system 120 may function to receive, store, and deliver the produced events. For instance, the messaging system 120 may receive the produced events via a respective communication link that connects the messaging system 120 with each producer. The communication links may include any one or more of point-to-point links, Personal Area Networks, Local-Area Networks (LANs), Wide-Area Networks (WANs) such as the Internet or cellular networks, cloud networks, and/or operational technology (OT) networks, among other possibilities. Further, the communication networks and/or links that make up each respective communication link may be wireless, wired, or some combination thereof, and may carry data according to any of various different communication protocols. The messaging system 120 may receive the produced events from each of the producers in other ways as well.

The messaging system 120 may store the produced events in various ways. As one example, the messaging system 120 may employ a data store, where the messaging system 120 stores each event in the data store as it is received. In some implementations, when the messaging system 120 delivers a produced event to one or more consumers that are designated to receive the event, the messaging system 120 may purge the event from the data store. In some other implementations, the messaging system 120 may employ an event log, where the messaging system 120 logs each given event in the event log as the given event is received. In such an implementation, when the messaging system 120 delivers a produced event to one or more of the consumers 130a-c, the messaging system 120 retains the event in the event log. This may be beneficial in some situations because it may allow the messaging system 120 to resend events if issues arise during delivery of the produced events. The messaging system 120 may store the produced events in other ways as well.

The messaging system 120 may deliver the produced events in various ways. As one example, the messaging system 120 may be configured to push the produced events to appropriate consumers. For instance, one or more consumers may subscribe to a given type of produced event (e.g., payment transaction events). Thereafter, when the messaging system 120 receives an event of the given type, the messaging system 120 pushes the given event to consumer 130a and consumer 130b. As another example, the messaging system 120 may publish received events in an event stream, which may be accessed by one or more consumers to retrieve the events. The messaging system 120 may deliver the produced events in other ways as well.

Each of the consumers shown in FIG. 1 may be configured to consume produced events, which might include optionally performing one or more additional operations associated with the event, as noted above. As one example, consumer 130a may be a pricing system that is configured to consume payment transaction events (e.g., events related to purchases made using credit cards) that are produced by a point-of-sale system producer. Consumer 130a may consume the payment transaction events and calculate a price to levy on each respective transaction (e.g., to be charged to the issuer of the credit card). As another example, consumer 130b may be a dispute system that is configured to consume dispute events (e.g., events produced each time a customer or another entity disputes a transaction). Consumer 130b may consume the events and calculate a fee to be levied on the dispute event (e.g., fees to be refunded). The event consumers may take other forms as well.

It should be noted that, in the context of the computing platform 100 shown in FIG. 1 and other similar computing platforms that implement an event-driven architecture, there may not be a one-to-one correspondence between a producer and a consumer for each produced event. For instance, a single event that originates from a given producer might be consumed by two or more consumers. Similarly, a given consumer might consume events produced by many different producers, which may then be aggregated before the given consumer carries out one or more operations on the aggregated event data. Various other examples are also possible.

In some implementations, the various software components within an event-driven architecture may produce and consume events in the form of an “unbounded” stream of events. An unbounded steam of events is a continuous stream of events with no defined beginning or end. In the context of an event-driven architecture, an unbounded stream of events means that producers can continuously produce events without temporal boundaries (e.g., the producers produce events as they occur, and the consumers consume events as they are received). In this regard, an unbounded stream of events can be useful for delivering data within a computing platform in real time, or close to real time. The discussion below and the following examples apply equally to both bounded and unbounded event streams.

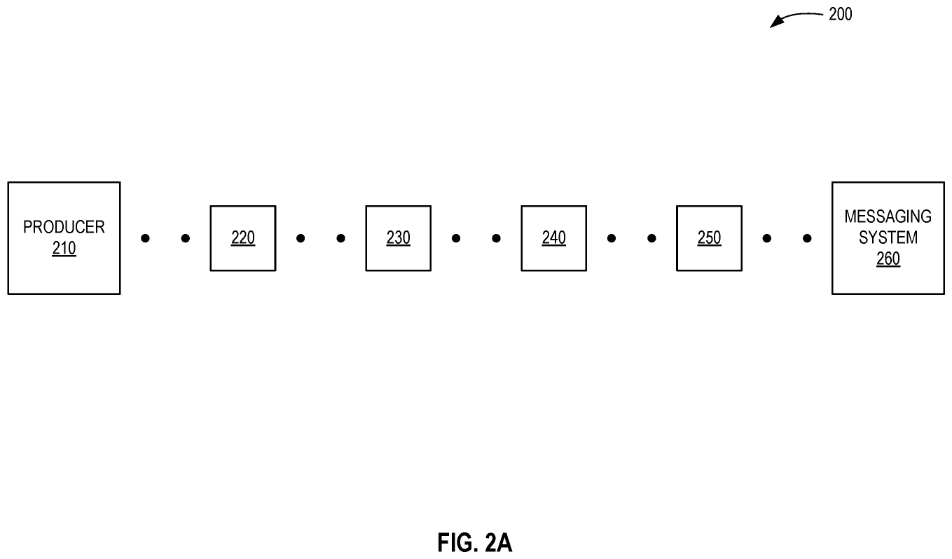

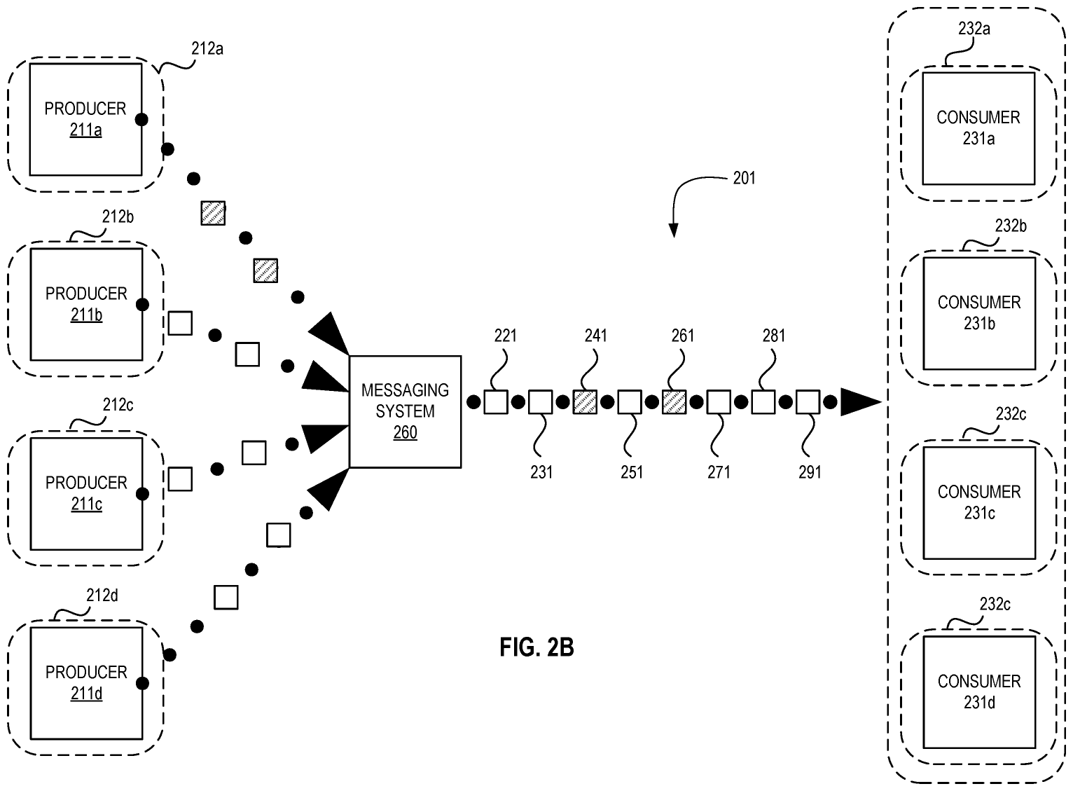

FIG. 2A shows one illustrative example of a stream of events within an event-driven architecture. In order to describe how the stream of events operates, it will be helpful to consider what events and event streams are.

An event may refer to a data record that indicates an action or some other type of change that is generated (e.g., initiated or detected) by a producer within an event-driven architecture. As noted above, producers within an event-driven architecture and the events those producers generate may take various forms (e.g., as noted above, a point-of-sale device may be a producer that generates an event for each sale or return that the point-of-sale device is used to perform). In one example form, an event may include an event header. Depending on the type of the event, the event header may take various forms.

In general, the event header for an event provides identifying information for the event and possibly classification labels for the event. For example, the event header may include metadata such as a timestamp (or multiple timestamps) associated with the event, an identifier (or multiple different types of identifiers) associated with the event (e.g., a GUID), a type of the event, a source of the event (which may be the producer that generated the event, but may also be a separate entity or phenomenon that is monitored by the producer). In other examples, other types of data may be included in the event header.

As suggested above, the event may also include an event payload. The event payload includes data that consumers that have subscribed to an event stream that includes the event are expected to consume in some way (e.g., take some type of action in response thereto). Depending on the type of the event, the event payload may take various forms.

In one illustrative example, suppose the event is a transaction in which a credit card is used to exchange a currency value (e.g., in U.S. dollars) between a seller and a buyer. In this example, the event header could comprise an identifier for the transaction, a timestamp indicating when the transaction was initiated, an attribute indicating one or more event streams for which the event is destined, and an attribute indicating that the transaction is for a currency value in U.S. dollars. The event payload, by contrast, may include data that could be used by downstream consumers to effectuate the transaction or record the transaction in a manner that identifies specific parties involved in the transaction and the amount of the transaction. Specifically, the event payload may include the primary account number (PAN) of the credit card, a merchant identifier associated with the seller, an identifier associated with the issuer of the credit card, an identifier associated with an acquiring bank, and an amount (e.g., in U.S. dollars) of the currency value that is exchanged via the transaction.

In another illustrative example, suppose the event is a medical insurance claim. In this example, the event header could comprise an identifier for the claim, a timestamp indicating when the claim was initiated, and a current procedure terminology (CPT) code for a type of medical procedure for which the claim is being submitted. The event payload, by contrast, may include information such as the name of a patient upon whom the medical procedure was performed, the name of the doctor who performed the procedure, a policy number for the medical insurance policy under which the patient is covered, a group plan number for the patient's employer, an identifier of the insurer, and a coverage amount indicating a percentage of the cost of the medical procedure that the insurer is willing to cover.

In scenarios where downstream consumers are configured to consume (e.g., take some action in response to) events of a particular type, it may be advantageous to consolidate events of the particular type into an event stream so that the downstream consumers can subscribe to the event stream. By subscribing to the event stream, the downstream consumers can be apprised (e.g., in real time or near real time) of events to which the downstream consumers are to react.

An event stream (i.e., a stream of events) is a sequence of events that are ordered by time. For example, if each event in an event stream is associated with a timestamp, the order of the events in the event stream indicates the order of the timestamps associated with those events. For example, if the timestamp associated with a given event in an event stream represents the time at which the given event was completed, events that precede the given event in the event stream may be presumed to be associated with timestamps that precede the timestamp associated with the given event. Furthermore, in some examples, the property of transitivity applies to events in the event stream (e.g., if a first event precedes a second event and the second event precedes a third event in the event stream, it may be presumed that the timestamp associated with the first event precedes the timestamp associated with the third event). However, in other examples, the events in a stream may not be strictly ordered by time for various reasons. For example, it is possible that a given event sent by the producer will have to be resent (e.g., due to network connectivity issues) and will therefore appear in an event stream after events that have timestamps that the timestamp of the given event precedes. Depending on the type or types of events included in the event stream, the timestamps associated with events in the event stream may take various forms.

The timestamp associated with an event in an event stream indicates a time at which some action associated with the event occurred. For example, the timestamp associated with an event may indicate a time at which the event occurred (e.g., commenced or ended), a time at which the event was detected, a time at which the event was reported, or some other time associated with the event. Note that more than one timestamp may be associated with an event. For example, an event may be associated with a first timestamp of a first type (e.g., a start time) and a second timestamp of a second type (e.g., an end time). In this example, the events in an event stream may be sorted according to respective associated timestamps of the first type, the respective associated timestamps of the second type, or some combination thereof (e.g., timestamps of the first type may be used as a primary sorting attribute, while timestamps of the second type may be used as a tie-breaker sorting attribute to determine the order in which two events that are associated with identical timestamps of the first type should appear in the event stream).

Returning to FIG. 2A, a first software component associated with a first computing system (e.g., a producer 210) produces and sends events to a second software component associated with a second computing system (e.g., a messaging system 260) as part of a stream of events 200. In FIG. 2A, event 220, event 230, event 240, and event 250 are depicted. However, the stream of events 200 may additionally include events both preceding event 220 and following event 250. In some implementations, each event produced by the producer 210 is promptly made available to the messaging system 260, which in turn may promptly make the events available to one or more downstream consumers. In some other implementations, the producer 210 may generate multiple events before making them available to the messaging system 260. In this regard, it should be understood that the producer 210 may produce event 220, event 230, event 240, and event 250 at any time. For instance, the four events shown in FIG. 2A might be produced approximately every 15 seconds over the course of one minute, or they might be produced at random times over the course of one hour or an entire day. Other examples are also possible.

However, a stream of events in an event-driven architecture may be associated with various drawbacks. Modern event-driven architectures are likely to be implemented at least partially in cloud computing environments. Consequently, both producers and downstream consumers may be physically located in many different geographical regions across the globe. As a result, producers and consumers that are constituents of a single event-driven architecture may be subject to the laws of different nations that have jurisdiction over the different geographical regions where the producers and consumers are located.

The disparate locations of producers and consumers in some event-driven architectures may have legal implications for entities that employ event-driven architectures because some laws impose restrictions on the geographical locations where certain types of data can be stored or processed.

For example, laws that govern how sensitive information is to be handled (e.g., where sensitive information is to be stored or processed) may vary widely across different jurisdictions. For example, some jurisdictions have strict laws that define personally identifiable information (PII), and further govern how and where PII and other types of sensitive information is to be handled and stored. In the United States, PII is defined in the U.S. Code of Federal Regulations (CFR) at 2 CFR § 200.79 as information that can be used to distinguish or trace an individual's identity, either alone or when combined with other personal or identifying information that is linked or linkable to a specific individual. Other jurisdictions define PII similarly.

The laws that govern how sensitive information such as PPI can be handled may take various forms. For example, the General Data Protection Regulation (GDPR), which applies in European Union (EU) member states, mandates that data collected about citizens of EU member states be stored in either the EU, such that the collected data is subject to EU privacy laws, or within another jurisdiction that has privacy laws parallel to those of the EU. In India, the Information Technology Act and the Information Technology (Reasonable Security Practices and Procedures and Sensitive Personal Data or Information) Rules (i.e., the “SPDI Rules”) also include regulations that restrict the locations where sensitive information about Indian citizens can be stored. For example, the SPDI rules mandate that data collectors (e.g., entities that receive, store, or otherwise process certain types of sensitive information about Indian citizens) adhere to directions issued by the Reserve Bank of India (RBI). For example, the RBI restricts banks and payment-system providers from storing payment-transaction data outside of India for transactions that are effected in India between Indian entities. As another example, in the U.S., the Health Insurance Portability and Accountability Act (HIPAA) prohibits certain entities from disclosing certain types of health data about individuals unless those individuals consent. Various other examples exist in other jurisdictions.

In addition, laws that address concerns other than privacy may also have implications for event-driven architectures that are implemented in cloud computing environments. For instance, laws that impose export restrictions, for example, may prohibit certain types of sensitive data (e.g., military technology) from being transmitted outside of a particular nation's borders. In addition, laws that impose sanctions on certain nations may mandate that certain types of information may not be transmitted to certain countries. Furthermore, copyright laws may prohibit entities from distributing data that is subject to copyrights held by third parties. Laws that have implications for event-driven architectures may also take other forms

Entities who fail to comply with such laws may face costly consequences, such as civil or criminal liability and fines of millions—or even billions—of dollars (e.g., in 2023, the Irish Data Protection Commission (DPC) issued a fine of €1.2 billion to a U.S.-based company for failing to comply with the GDPR). In addition to civil and criminal penalties, entities who fail to comply with such laws may suffer reputational damage, a loss of brand value, and a loss of public trust.

Even in scenarios where national and international laws restricting where data may be transferred, stored, or processed based on location do not directly apply, an entity that employs an event-driven architecture may encounter other types of concerns that center around network locations (and the network security policies enforced therein) as opposed to geographical locations. For example, an entity may be obligated by a contract with a third party to ensure that the third party's data is stored in network locations where very strict network security policies are enforced. Breach of such a contract could result in civil liability or a loss of a working relationship with the third party. In another example, an entity that wishes to protect a particular trade secret may risk that trade secret losing its protections under the applicable laws (e.g., the U.S. Defend Trade Secrets Act (DTSA)) if the network location where the trade secret is stored is not protected by network security policies that amount to reasonable measures to keep the trade secret private.

Turning now to FIG. 2B, an illustrative example is provided in which producers 211a-d produce events and send those events to the messaging system 260 for inclusion in the stream of events 201. The messaging system 260 may function to receive, store, and deliver the produced events to the consumers 231a-c via the stream of events 201.

FIG. 2B depicts eight events (i.e., events 221, 231, 241, 251, 261, 271, 281, 291). However, the producers 211a-d may produce and send any number of events that precede event 221 or follow event 291. The messaging system 260 may include those preceding or following events in the stream of events 201. In some implementations, events produced by the producers 211a-d may be promptly transmitted to the messaging system 260 by at least some of the producers 211a-d. The messaging system 260, in turn, may promptly make those events available to the consumers 231a-d via the stream of events 201. In some other implementations, at least some of the producers 211a-d may generate multiple events before transmitting those events (e.g., in batches) to the messaging system 260. In this regard, it should be understood that the producers 211a-d may produce the events 221, 231, 241, 251, 261, 271, 281, 291 at any time. Other examples are also possible.

In FIG. 2B, the producer 211a is located in the area 212a. Similarly, the producer 211b is located in the area 212b, the producer 211c is located in the area 212c, and the producer 211d is located in the area 212d. In addition, the consumer 231a is located in the area 232a, the consumer 231b is located in the area 232b, the consumer 231c is located in the area 232c, and the consumer 231d is located in the area 232d.

To illustrate a problem that may arise in the context of event-driven architectures that are implemented in cloud computing environments (or other computing environments that employ computing resources distributed across different locations), consider the following example scenario. Suppose the area 212a is located in a country that prohibits (e.g., by law) a particular type of data from being transmitted to locations outside the country. Further suppose that the events 241, 261 were produced by the producer 211a (which, as noted above, is located in the area 212a) and contain data of the particular type (e.g., PII, export-controlled data, etc.). In addition, suppose that the area 232a and the area 232c are located outside the country in which the area 212a is located.

In this scenario, transmitting the stream of events 201 to the consumers 231a, 231c would violate the law of the country because (i) the stream of events 201 includes the events 241, 261; (ii) the events 241, 261 contain data of the particular type that is prohibited from being transmitted outside the country; (iii) the producer 211a, which produced the events 241, 261, is located in 212a which is located in the country; and (iv) consumers 231a, 231c are located outside the country. However, if the messaging system 260 does not transmit the stream of events 201 to the each of the consumers 231a-d, the consumers 231a-d may not receive data that the consumers 231a-d are expected to consume and may therefore be unable to perform functions that the consumers 231a-d are configured to perform.

One possible approach for addressing this problem would be for the messaging system 260 not to include the events 241, 261 (and other events produced by the producer 211a that contain the particular type of data) in the stream of events 201. This approach, however, would effectively render the events 241, 261 (and other events produced by the producer 211a that contain the particular type of data) useless from a practical standpoint. It would be wasteful, for example, to dedicate computing resources (e.g., processor and network bandwidth) to transmit events from the producer 211a to the messaging system 260 if such events were not going to be included in any event stream.

More importantly, this approach is problematic because it does not provide the consumers 231a-d with the full stream of events 201 to which the consumers 231a-d have subscribed. As a result, the consumers 231a-d may receive insufficient data to perform certain functions the consumers 231a-d are configured to perform—even if a subset of the consumers 231a-d (e.g., consumers 231b, 231c) are located in the country and could therefore receive and consume the events 241, 261 without any laws being violated. Furthermore, the consumers 231a-d may be configured to operate based on an assumption that the stream of events 201 represents a complete record of events of the event type(s) that are supposed to be included in the stream of events 201. As a result, the consumers 231a-d may generate incorrect outputs based on this assumption and propagate those erroneous outputs to other systems. Furthermore, in various contexts, omitting the events 241, 261 from the stream of events 201 may obfuscate attempts to establish audit trails for complying with legal obligations and to generate error traces (e.g., stack traces) for debugging purposes.

The problems described above with respect to omitting events from a stream may be particularly applicable when the computing platform that implements the event driven architecture depicted in FIG. 2B is operated by a financial services institution, as problems with compliance and stream continuity may directly affect the processing of payment transactions, the collection of fees, and/or customer satisfaction. For instance, if an event is generated that pertains to a disputed transaction and that event is never delivered to the appropriate consumer, the disputed transaction may not be resolved promptly, or at all, which in turn may result in poor customer satisfaction and economic losses.

In view of these challenges, disclosed herein is a new technology that facilitates supplying an event stream via an event-driven architecture that complies with constraints (e.g., that are mandated by law or policy) about where data can be stored or processed without obfuscating the event stream. The technologies described herein replace events to which constraints apply with placeholder events that omit (e.g., via redaction) sensitive data pertinent to those constraints, but also contain sufficient data to inform authorized consumers of how to access the unredacted versions of those events that were replaced by the placeholder events in the event stream. The placeholder events allow the event stream to accurately reflect that the events occurred (and when the events occurred), even for consumers who are not allowed to access the events that have been replaced by the placeholder events. Alternatively, in scenarios in which applicable constraints restrict access to sensitive data based on criteria other than location (e.g., based on a user's access privileges rather than on the user's location), the placeholder event (or, alternatively, the event itself) may include an encrypted or otherwise obfuscated version of the sensitive data, without obfuscating the event stream itself. Unlike existing solutions that screen data-sensitive events from event streams entirely, the technology of the present disclosure does not sacrifice the integrity of the event stream in order to comply with applicable constraints. Other advantages will also become evident in the disclosure below.

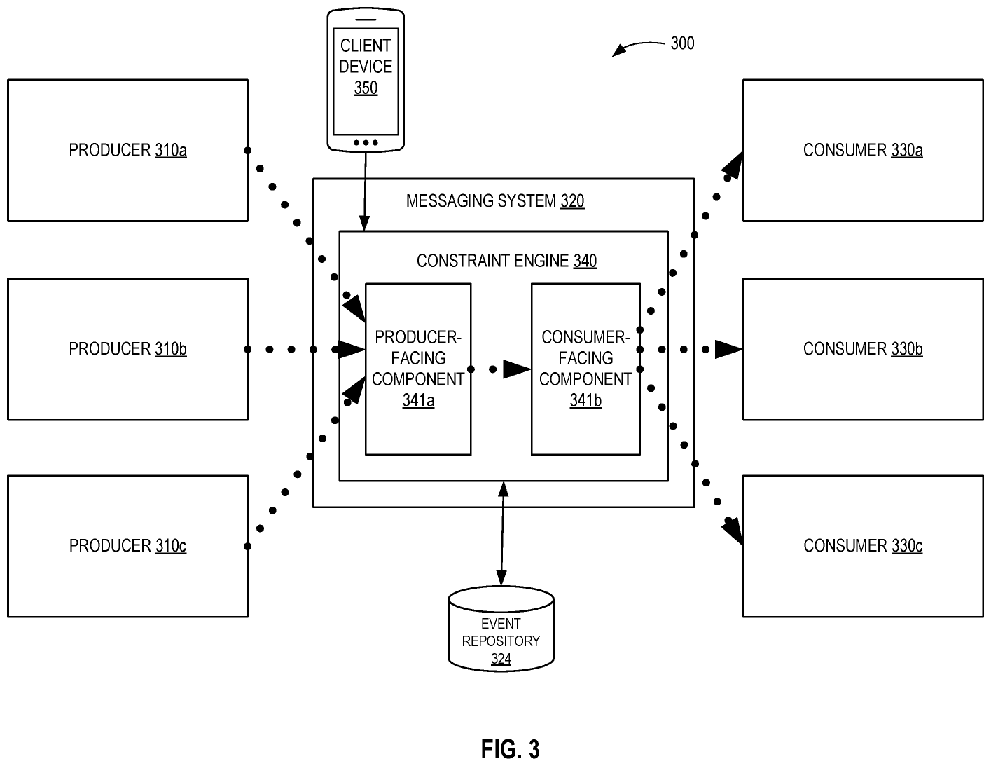

Turning now to FIG. 3, an illustrative example of a computing platform 300 implementing an event-driven architecture that incorporates a constraint engine 340 is shown. The event-driven architecture includes one or more event producers, illustrated by way of example as producer 310a, producer 310b, and producer 310c. The event-driven architecture also includes a messaging system 320 and one or more event consumers, illustrated by way of example as consumer 330a, consumer 330b, and consumer 330c. The event producers may be configured to produce events associated with the computing platform 300 and may take various forms, as explained above with respect to FIG. 1. As one possibility, the producer 310a may be a point-of-sale system that is configured to produce payment transaction events each time an item is purchased. Accordingly, each event may be a data object that includes information about the payment transaction. For instance, each event may be organized according to a schema that defines certain data fields (e.g., a GUID, a merchant identity, a payment amount, a transaction date, a transaction time, etc.) and corresponding values for the included data fields.

As another possibility, event producer 310b may be a customer service system that is configured to produce an event each time a dispute related to a payment transaction event is initiated (e.g., each time a business or customer disputes a transaction). Accordingly, each event may be a data object that includes information about the disputed transaction. For instance, a disputed transaction event may include a schema that may define different data fields (e.g., the disputed payment event's GUID, a merchant identity, a disputed payment amount, etc.) and corresponding values for those data fields. The event producers, and the associated events they produce, may take many other forms as well.

Like the producers shown in FIG. 1, each of the producers shown in FIG. 3 may be configured to produce events and send those events to the messaging system 320. In this respect, the messaging system 320 may function to receive, store, and deliver the produced events. For instance, the messaging system 320 may receive the produced events via a respective communication link that connects the messaging system 320 with each producer. The communication links may include one or more of point-to-point links, personal area networks, LANs, WANs such as the Internet or cellular networks, cloud networks, and/or OT networks, among other possibilities. Further, the communication networks and/or links that make up each respective communication link may be wireless, wired, or some combination thereof, and may carry data according to any of various different communication protocols. The messaging system 320 may receive the produced events from each of the producers in other ways as well.

However, unlike the messaging system 120 of FIG. 1, the messaging system 320 includes a constraint engine 340 that functions to evaluate events received from the producers 310a-c against a set of constraints. For simplicity in illustration, the constraint engine 340 is shown as part of the messaging system 320. However, the constraint engine 340 may also be implemented separately from the messaging system 320 such that the constraint engine 340 interfaces with the messaging system 320 to perform the functions ascribed to the constraint engine 340 herein.

Like the messaging system 120 of FIG. 1, the messaging system 320 may store the produced events in various ways. As one example, the messaging system 320 may employ a data store where an event may be stored as it is received, provided that no constraint (as described further below) prohibiting the event from being stored in the data store applies to the event (i.e., the event is “unconstrained”). In some implementations, when the messaging system 320 delivers such a produced event to one or more consumers that are designated to receive the event, the messaging system 320 may purge the event from the data store. In some other implementations, the messaging system 320 may employ an event log, where the messaging system 320 logs each unconstrained event that is in the event log as it is received. In such an implementation, when the messaging system 320 delivers such an event to one of the consumers 330a-c, the messaging system 320 retains the event in the event log. This may be beneficial in some situations, as it may allow the messaging system 320 to resend events if issues arise during delivery of the produced events. The messaging system 120 may store the produced events in other ways as well.

Regarding an event to which one or more constraints apply (i.e., a “constrained” event), a producer-facing component 341a of the constraint engine 340 may determine that the event is a constrained event, as explained in further detail below. Based on this determination, the messaging system 320 may store the constrained event in an event repository 324. While the event repository 324 is shown as a single unit for clarity in illustration, the event repository 324 may include multiple repositories that are located in multiple locations such that constrained events may be stored in compliance with applicable constraints (e.g., as described in greater detail below). Furthermore, in some examples, different respective information technology (IT) protocols may be enforced within these multiple repositories to ensure that constrained events may be stored in compliance with applicable constraints.

When an event is received at the messaging system 320, the event is routed to the producer-facing component 341a of the constraint engine 340 to be evaluated against the set of constraints. The set of constraints may be configurable such that a user may access an interface for the constraint engine 340 via the client device 350 to provision the constraint engine 340 with the constraints that the user wishes to include in the set. The user may select existing constraints that have previously been defined or define additional constraints to be included in the set. The user may select or deselect constraints to include in the set as desired. A constraint may comprise, for example, a triggering condition and one or more actions to be taken for events that satisfy the triggering condition. The constraints in the set may take various forms.

As one possibility, one type of constraint may specify that an event that originates from (e.g., is produced, detected, or generated by) a producer located in a first geographical region (e.g., a particular country or a group of countries) is not to be transmitted to any consumer that is located in a second geographical region (e.g., a location that lies outside of the particular country or group of countries). Thus, the one or more actions to be taken when the triggering condition (e.g., the event originating from the particular country or group of countries) is satisfied may comprise (i) replacing the event in the event stream with a placeholder event and (ii) causing the event to be stored in an event repository (e.g., the event repository 324) that is located in the particular country or group of countries. This type of constraint could be used, for example, to ensure compliance with the SPDI rules of India, the GDPR of the EU, or other laws or mandates (e.g., sanctions). In any given instantiation of this type of constraint, the particular country or group of countries on which the triggering condition for this type of constraint will be based may vary according to the specific law, rule, or guideline that the constraint is configured to represent.

As another possibility, another type of constraint may specify that an event that includes a particular type of data (e.g., data to which export controls apply) is not to be transmitted to any consumer that lies outside of the particular country or group of countries from which the event originates. Like the constraint mentioned in the previous paragraph, this constraint prohibits transmitting an event to particular locations. However, unlike the constraint mentioned in the previous paragraph, the triggering condition for this constraint is based on the content of the event as well as the location from which the event originates. Thus, the one or more actions to be taken when the triggering condition (e.g., the event including the particular type of data) is satisfied may include (i) replacing the event in the event stream with a placeholder event and (ii) causing the event to be stored in an event repository (e.g., the event repository 324) that is located in the particular country or group of countries. In any given instantiation of this type of constraint, the particular country (or group of countries) and data types on which the triggering condition for this type of constraint will be based may vary according to the specific law, rule, or guideline that the constraint is configured to represent.

As another possibility, another type of constraint may specify that events whose payloads contain specific types of data (e.g., PII, trade secrets, etc.) are not to be transmitted to consumers in which certain types of IT protocols (e.g., network security protocols, password protection, etc.) are not enforced. Thus, the one or more actions to be taken when the triggering condition (e.g., the event including the particular type of data) is satisfied may include (i) replacing the event in the event stream with a placeholder event and (ii) causing the event to be stored in an event repository (e.g., the event repository 324) in which the certain types of IT protocols are enforced. This type of constraint may be used, for example, to ensure compliance with laws mandating that those specific types of data be stored in event repositories in which such IT protocols are enforced. In any given instantiation of this type of constraint, the particular IT protocol(s) on which the triggering condition for this type of constraint will be based may vary according to the specific law, rule, or guideline that the constraint is configured to represent.

As another possibility, another type of constraint may specify that consumers who lack certain types of permissions (e.g., access privileges such as administrative access privileges and paid subscription privileges) not be allowed to access a particular type of data that stored in event payloads. There are many types of data that may be confidential (e.g., sensitive) and should therefore be protected by this type of constraint as part of an information-security policy. Thus, confidential data may take various forms. For example, social security numbers and other types of PII have many legitimate uses (e.g., to perform credit checks, verify citizenship status, etc.), but can also be used to facilitate identity theft. Similarly, biometric data (e.g., fingerprints, voiceprints, retina scans, etc.) can be used to authenticate a person, but may also be used by an impostor to gain access to that person's private data or assets. Medical data (e.g., diagnoses, lab results, genetic testing results from DNA or RNA analyses, etc.) can provide valuable information about patients, but can also be leveraged by bad actors against the patients for unethical purposes (e.g., extortion, discrimination, etc.). Educational assessments and opinions (e.g., grades, standardized test scores, letters of recommendation, etc.) may be used for legitimate purposes (e.g., admissions decisions, class placement, etc.), but may also be used by bad actors to embarrass or sabotage rival students. Commercially sensitive information (e.g., internal projects that are still in development, settlement amounts from lawsuits, etc.) and intellectual property (e.g., trade secrets) can provide advantages to businesses, but can also be used by competitors to nullify or steal those advantages. It may also be desirable to restrict access to other types of information, such as information that is held behind a paywall to incentivize consumers to purchase subscriptions to a service or information that is tagged with a particular security classification (e.g., “internal only,” “classified,” “top secret,” etc.). Confidential data may also take any of various other forms. Regardless of the form of such confidential data, though, the presence of confidential data in an event may serve as a triggering condition for a permission-based constraint.

Permission-based constraints may apply to an event in parallel with other types of constraints (e.g., location-based constraints). However, for the sake of simplicity in illustration, consider a scenario in which a given event includes a social security number and a single constraint applies—namely, a permission-based constraint specifying that unencrypted social security numbers not be published in an event stream that can be accessed by consumers who lack permission to access social security numbers. In this scenario, the one or more actions to be taken when the triggering condition (e.g., that the event includes a social security number) is satisfied may include encrypting the social security number in the event before publishing the event (or placeholder event) in the event stream. In this scenario, a first encryption key (e.g., a public Rivest-Shamir-Adleman (RSA) key) and a second encryption key (e.g., a private RSA key) may be associated with the sufficient permission. The first encryption key and the second encryption key may have been generated beforehand (e.g., by the messaging system 320 or by some other agent). The second encryption key is provided to those of the consumers who have the sufficient permission to access social security numbers via a highly secure method of communication (e.g., via respective encrypted electronic channels between the consumer-facing component 341b and the consumers 341a,b,c or via in-person delivery without electronic transmittal). The consumer-facing component 341b (or another part of the constraint engine 340 or the messaging system 320) encrypts the social security number using the first encryption key in the event before the event is published in the event stream. Those of the consumers 330a,b,c who have sufficient permissions to access the social security number can use the second encryption key to decrypt the social security number. Given the absence of location-based constraints in this example, the action of causing the event to be stored in an event repository may optionally be omitted. However, in other examples in which location-based constraints apply in parallel with permission-based constraints, the event may be stored in the event repository 324 with the encrypted version of the social security number and a placeholder event may be published in the event stream. (While the social security number was used in this example, any other type of confidential data could be handled similarly.) In this manner, both location-based constraints and permission-based constraints may be applied in parallel.

Other types of constraints may also be used without departing from the spirit and scope of this disclosure. The types of constraints described above are merely provided as illustrative examples.

If the producer-facing component 341a determines that a given event is unconstrained, the producer-facing component 341a provides the given event to the consumer-facing component 341b for delivery to the consumers 330a-c. However, if the producer-facing component 341a determines that at least one of the constraints in the set of constraints applies to a given event, the producer-facing component 341a replaces the given event with a placeholder event. The placeholder event omits at least a portion of the data included in the given event in accordance with the one or more actions specified by the applicable constraint(s). Nevertheless, the producer-facing component 341a causes the given event to be stored in the event repository 324 in accordance with the applicable constraint(s). As noted above, the event repository 324 is compliant with the one or more actions specified by the applicable constraint(s) (e.g., the location of the event repository 324 and the IT protocols enforced upon the event repository 324 do not violate any restrictions specified by the one or more actions). In addition, the producer-facing component 341a may add metadata to the placeholder event to specify where the given event is stored (e.g., in the event repository 324) and who is allowed to access the given event. For example, the metadata added to the placeholder event may include a location identifier, a uniform resource indicator (URI), and an access role or authorization level. The producer-facing component 341a provides the placeholder event to the consumer-facing component 341b in place of the given event for delivery to the consumers 330a-c.

The consumer-facing component 341b may deliver the unconstrained events and the placeholder events in various ways. As one example, the consumer-facing component 341b may be configured to push the unconstrained events and the placeholder events to appropriate consumers. For instance, suppose the consumers 330a-c subscribe to a given type of produced event (e.g., payment transaction events). Thereafter, when the consumer-facing component 341b receives an unconstrained event or a placeholder event of the given type from the producer-facing component 341a, the consumer-facing component 341b pushes the unconstrained event or placeholder event to the consumers 330a-c. As another example, the consumer-facing component 341b may publish the unconstrained events and the placeholder events in an event stream, which may be accessed or retrieved by the consumers 330a-c. The consumer-facing component 341b may deliver the unconstrained events and the placeholder events in other ways as well.

Regarding constrained events that are stored in the event repository 324, the consumer-facing component 341b may still make such constrained events available to consumers who are not prohibited from receiving those constrained events. To illustrate how the consumer-facing component 341b may accomplish this, consider the following example. Suppose the producer-facing component 341a detects that a single constraint applies to a given event, causes the given event to be stored in the event repository 324, and provides a placeholder event to the consumer-facing component 341b in place of the given event. The consumer-facing component 341b may then transmit the placeholder event to the consumers 330a-c in an event stream in place of the given event. In this example, suppose the constraint prohibits the given event from being transmitted to a location where the consumer 330a is located, but does not prohibit the given event from being transmitted to a location where the consumer 330b is located. Further suppose that the consumer 330b, after receiving the placeholder event in the event stream, transmits a message to the consumer-facing component 341b to request the given event, and that the message includes the metadata from the placeholder event that specifies the given event is stored in the event repository 324. The message may also indicate the location of the consumer 330b. In response to receiving the message and verifying that the applicable constraint does not prohibit transmitting the given event to the location of the consumer 330b, the consumer-facing component 341b retrieves the given event from the event repository 324 and transmits the given event to the consumer 330b. This example illustrates how the given event may be provided upon request to consumers who are not prohibited from receiving the given event by the applicable constraint.

In another example, the consumer-facing component 341b may be configured to identify which of the consumers 330a-c are prohibited (e.g., due to location) from receiving the given event before transmitting the placeholder event to the consumers 330a-c (e.g., in an event stream). In this example, suppose the consumer-facing component 341b determines that the consumer 330a is prohibited from receiving the given event, but the consumer 330b and the consumer 330c are not. The consumer-facing component 341b proceeds with transmitting the placeholder event to the consumer 330a, but not to the consumer 330b and the consumer 330c. Instead, the consumer-facing component 341b retrieves the given event from the event repository 324 and transmits the given event to the consumer 330b and the consumer 330c. This example illustrates how the given event may be pushed to consumers who are not prohibited from receiving the given event by the applicable constraint. In this way, such consumers can receive the event without having to send a message to request the given event.

Regardless of how the constrained events are made available via the consumer-facing component 341b, the constraint engine 340 provides advantages over existing techniques that merely omit events from event streams. By using placeholder events in the manner described, the constraint engine 340 maintains stream continuity that is compliant with applicable laws and policies. Furthermore, the constraint engine 340 operates such that any consumers that are not prohibited from receiving constrained events (i) know that the constrained events occurred and (ii) have sufficient information to request the constrained events and thereby facilitate downstream processes that could not otherwise be completed without data found in the constrained events. In the case where a computing platform that implements event stream is operated by a financial services institution, this may enable payment transactions to be processed promptly and seamlessly.

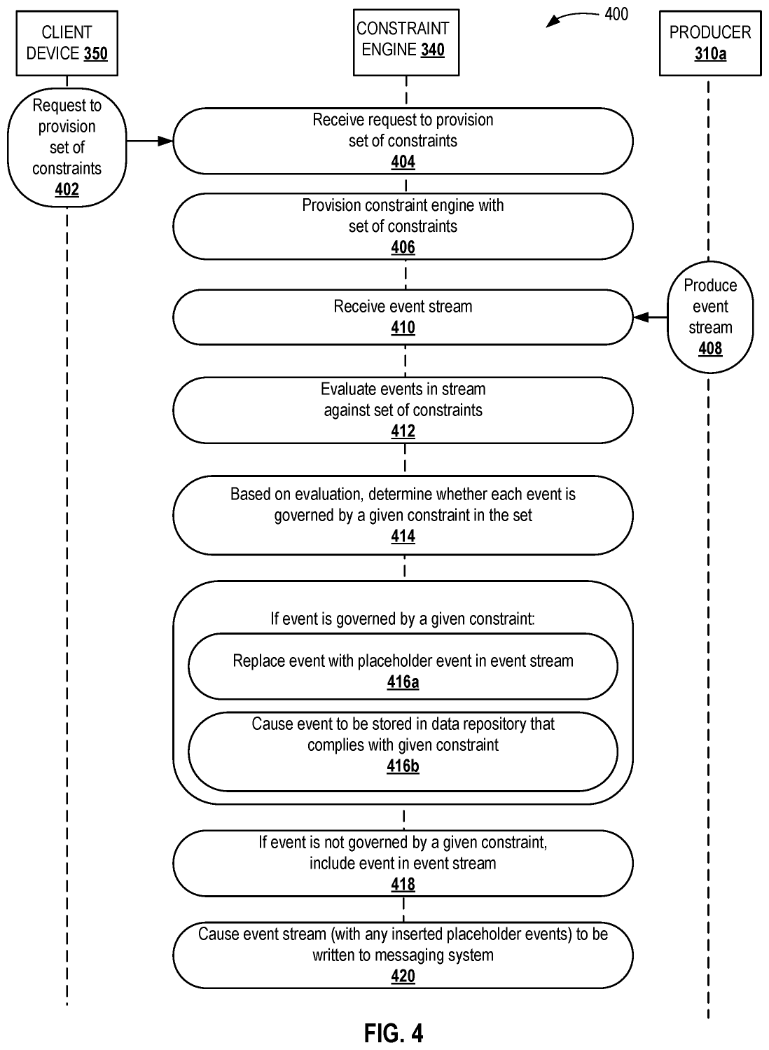

Turning now to FIG. 4, an example process 400 that may be performed in an event-driven architecture for constraint enforcement is shown. The operations depicted in FIG. 4 and described below may be carried out by a computing system that is installed with a constraint engine, such as the constraint engine 340 shown in FIG. 3 and discussed above. For the purposes of the following examples, some operations shown in FIG. 4 will be discussed as being carried out by the messaging system 320 of FIG. 3 that houses the constraint engine 340. While the example process 400 is provided for illustrative purposes, other variations of processes for constraint enforcement may also be applied. For example, some variations may include additional actions not depicted in the example process 400 or may omit actions that are depicted in the example process 400. Furthermore, some of the actions shown in the example process 400 may be performed in an order other than the order shown in the example process 400.

The example process 400 may begin at block 402 when a client device (e.g., the client device 350) transmits a request to provision the constraint engine 340 with a set of constraints that a user wishes to apply to events to be included in an event stream. At block 404, the messaging system 320 receives the provisioning request with the set of constraints. As noted above with respect to FIG. 3, the constraints in the set may take various forms. For example, some examples of triggering conditions that could be used for a constraint in the set for any given event could include (i) a location (e.g., area, network, geographical region, zone, etc.) where the given event was produced, (ii) a type(s) of the given event, (iii) a type of data included in the given event, or (iv) some other detectable aspect of the given event. Note that a triggering condition may also be created by combining (e.g., by conjunction, inclusive disjunction, exclusive disjunction, etc.) multiple individual triggering conditions.

At block 406, the constraint engine 340 is provisioned with the set of constraints as requested. For example, the messaging system 320 that is installed with the constraint engine 340 (e.g., as shown in FIG. 3) may receive the request to provision the constraint engine 340 at block 404 and may cause the constraint engine 340 to be provisioned accordingly at block 406. Once the constraint engine 340 has been provisioned with the set of constraints, the constraint engine 340 will enforce the set of constraints by evaluating received events against the set of constraints and, for events to which a particular constraint applies, ensuring that the action(s) specified by the particular constraint are taken.

Block 408 involves a producer (e.g., the producer 310a) producing an event stream that is transmitted to the messaging system 320 of FIG. 3 (which includes the constraint engine 340). Events included in the event stream may take various forms. For example, as noted above, a change in state in a computing platform that implements an event-driven architecture (e.g., that includes the constraint engine 340) may constitute an event. If the event-driven architecture facilitates e-commerce transactions, an event may include a purchase order, a product availability inquiry, an item return, or some other type of transaction. As another example, if the event-driven architecture facilitates social media interactions across a social media platform, an event may include a notification that a user has posted an update (e.g., a message, a photo, a reaction to another user's post, etc.). As yet another example, if the event-driven architecture facilitates the management of IoT devices, an event may include a temperature sensor reading from a network-connected thermostat or a proximity alert from a network-connected motion detector, among other possibilities.

Block 410 involves the messaging system 320 of FIG. 3 (which includes the constraint engine 340) receiving the event stream sent by the producer 310a. Once the event stream has been received, the messaging system 320, via the constraint engine 340, proceeds to apply the set of constraints to the event stream accordingly.

Specifically, block 412 involves the constraint engine 340 evaluating events in the stream against the set of constraints. For example, the constraint engine 340 compares events in the event stream to the triggering conditions to detect any events that satisfy the triggering conditions for any constraints in the set. Depending on how the triggering conditions are defined and the specific types of data included in the events, the way in which the comparison is achieved may take various forms. For example, if a triggering condition for a constraint is that a particular attribute of an event matches at least one of a set of possible values enumerated in the triggering condition, the comparison may be achieved through one or more simple Boolean comparisons. For example, if the attribute is stored in memory as a string data type, the comparison may involve an existing operator or function for string comparison (e.g., the “==” operator in the Python programming language or in JavaScript). If the attribute on which a triggering condition depends is stored in memory as a numeric data type (e.g., an integer or a real number), numeric operators may be used to achieve the comparison. More complicated types of comparisons are also possible. For example, if the triggering condition involves detecting the presence of sensitive data in unstructured text included in the payload of the event, natural-language processing (NLP) techniques may be used to determine if the triggering condition is satisfied.

Block 414 involves the constraint engine 340 determining whether each event is governed by a given constraint found in the set of constraints. If the event is governed by a given constraint (or multiple constraints) found in the set, various actions may be taken. As one example, shown at block 416a, the constraint engine 340 may generate a placeholder event that is used to replace the event in the event stream. In addition, at block 416b, the constraint engine 340 causes the event to be stored in a data repository (e.g., the event repository 324) that complies with the given constraint. For example, if the given constraint prohibits storing the given event in a particular location, a data repository that is not located in that particular location is used to store the event. In another example, if the given constraint mandates that a particular IT protocol be enforced upon any data repository where the event is to be stored, a data repository that is subject to the particular IT protocol is used to store the event.

On the other hand, at block 418, if the event is not governed by any constraints found in the set of constraints, the constraint engine 340 includes the event in the event stream (e.g., without modification) that is to be transmitted to consumers.

Block 420 involves causing the event stream, including any unconstrained events and placeholder events included therein, to be written to the messaging system that is served by the constraint engine 340. This may, for example, involve signaling the messaging system to transmit the event stream to consumers who have subscribed to the event stream. Within the context of FIG. 4, the constraint engine 340 has been referred to as a component of the messaging system 320. However, as mentioned above, the constraint engine 340 may be implemented by other computing systems within the over-arching computing platform of an event-driven architecture as well.

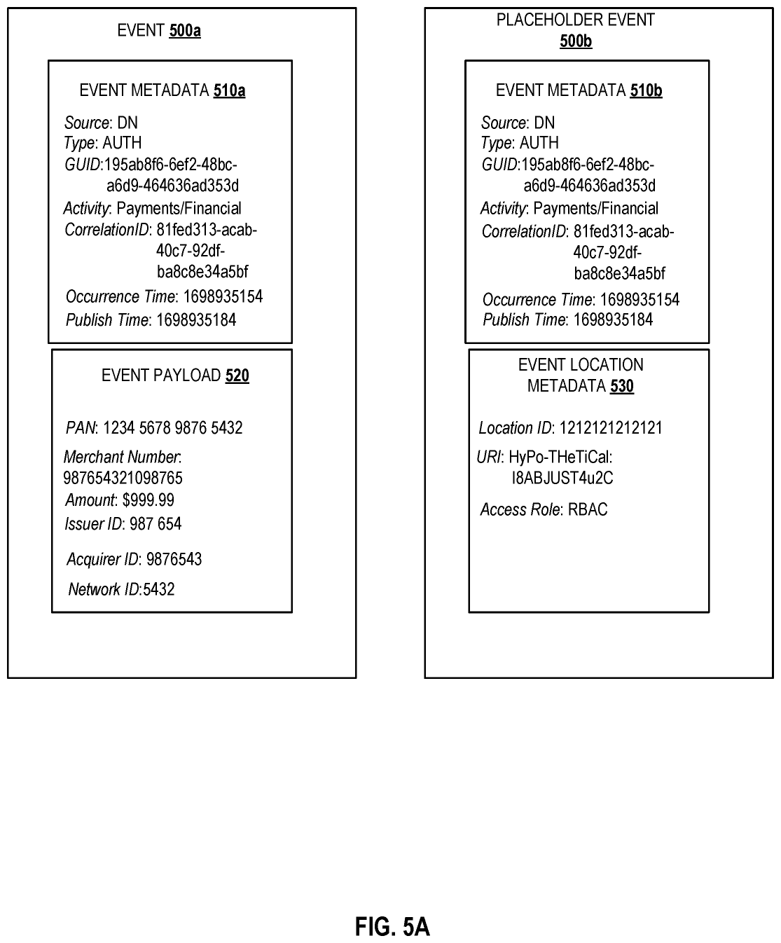

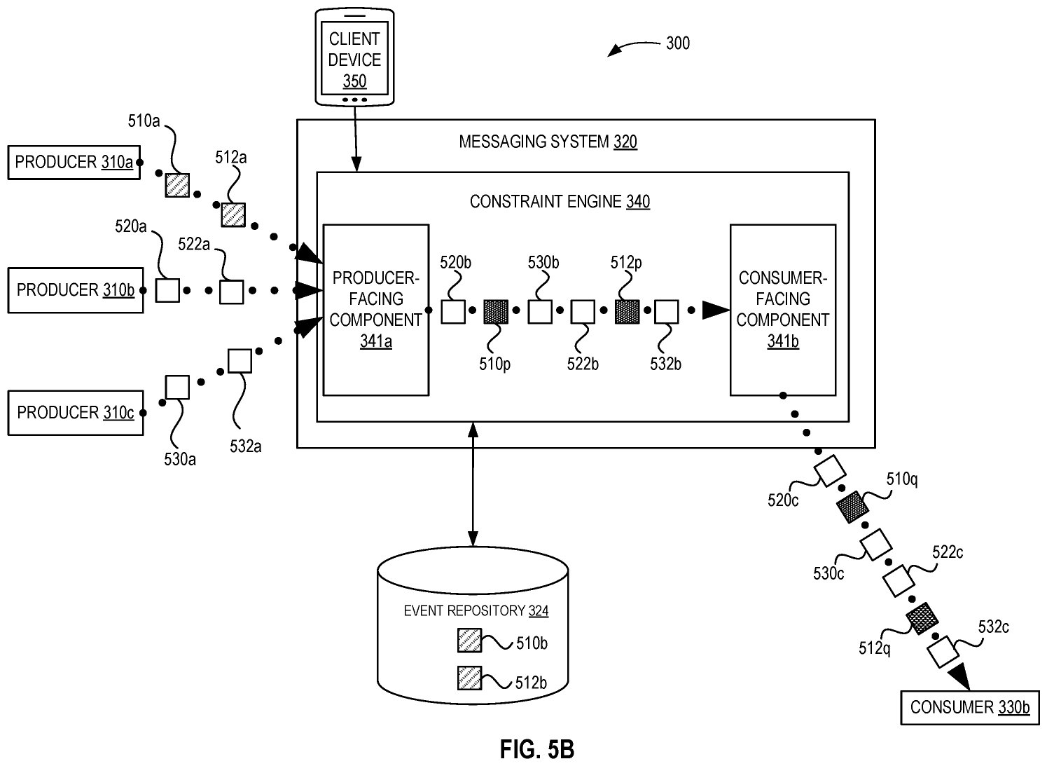

Turning to FIG. 5A, illustrative examples of a constrained event 500a and a corresponding placeholder event 500b are depicted. The event 500a includes both event metadata 510a and an event payload 520. As shown, the event metadata 510a includes data that can be used to identify the event 500a (e.g., a GUID), a source of the event 500a, a type of the event 500a, an activity type associated with the event 500a, an identifier of another element (e.g., a transaction to which the event 500a pertains or another event) that is associated with the event 500a, and two different timestamps that identify an occurrence time and a publishing time, respectively, of the event 500a.

As shown, the event payload 520 includes more sensitive information, such as a primary account number (PAN) of a credit card used in the transaction to which the event 500a pertains, a currency value for the transaction, a merchant number that identifies a merchant who was designated to receive the currency value in the transaction, an issuer identifier that indicates the issuer (i.e., issuing bank) that issues credit to a holder of the card, an acquirer identifier that indicates a bank that processes the transaction on behalf of the merchant, and a network identifier.

Since the data in the event payload 520 is sensitive (e.g., includes PII, etc.), the event 500a may satisfy a triggering condition for a constraint that mandates the data in the payload not be made available to at least some consumers that subscribe to an event stream in which the event 500a would otherwise be included. As a result, a constraint engine may generate the placeholder event 500b for inclusion in the event stream in place of the event 500a. As shown, the event metadata 510b included in the placeholder event 500b matches the data in the event metadata 510a. (Note, however, that other examples may involve redacting some data from event metadata as well as an event payload). However, the placeholder event 500b does not include the data shown in the event payload 520 of the event 500a. Instead, the placeholder event 500b includes the event location metadata 530. The event location metadata 530 includes data for identifying where the event 500a is stored (e.g., in a particular data repository that does not violate any applicable constraints in the set of constraints). The data included in the event location metadata 530 may be used by a consumer who receives the placeholder event 500b in the event stream to request a copy of the event 500a. In this example, the event metadata includes a location identifier for the place where the event 500a is stored (e.g., a global location number (GLN) or some other type of location identifier, such as a country code), a URI, and an access role (e.g., to identify a level of authorization that is sufficient for access to the event 500a to be granted).

Turning to FIG. 5B, an example scenario in which the computing platform 300 performs processes described herein (e.g., the example process 400 shown in FIG. 4) is provided to show how constrained events and unconstrained events flow through the messaging system 320 in an event stream.

In this example, the producer 310a produces the events 510a, 512a and transmits them to the messaging system 320, where there are received by the producer-facing component 341a of the constraint engine 340. Similarly, the producer 310b produces the events 520a, 522a and transmits them to the messaging system 320, where they are received by the producer-facing component 341a. In addition, the producer 310c produces the events 530a, 532a and transmits them to the messaging system 320, where there are received by the producer-facing component 341a. As noted above, other implementations are also possible in which the constraint engine 340 is installed on an intermediate computing system (not shown) that receives the produced events for analysis by the constraint engine 340 before the events are routed to the messaging system 320.

In the example shown in FIG. 5B, producer-facing component 341a determines that each of the events 510a, 512a, 520a, 522a, 530a, 532a should be included in an event stream to which the consumer 330b subscribes (e.g., due to the events 510a, 512a, 520a, 522a, 530a, 532a being events of an event type that is to be included in the event stream). Accordingly, the producer-facing component consolidates the events 510a, 512a, 520a, 522a, 530a, 532a into an event stream and sorts them (e.g., according to timestamps).

The producer-facing component 341a evaluates the events 510a, 512a, 520a, 522a, 530a, 532a against a set of constraints (e.g., that were previously provided by the client device 350). The producer-facing component 341a determines, based on the evaluation, that the events 520a, 522a, 530a, 532a are not governed by any constraints included in the set of constraints. However, the producer-facing component 341a also determines that a particular constraint included in the set does govern the events 510a, 512a.

In response to determining that the particular constraint governs the event 510a, the producer-facing component 341a replaces the event 510a with the placeholder event 510p in the event stream. Similarly, in response to determining that the particular constraint governs the event 512a, the producer-facing component 341a replaces the event 512a with the placeholder event 512p in the event stream. However, the producer-facing component 341a includes unmodified copies of the events 520a, 522a, 530a, 532a in the event stream—namely, events 520b, 522b, 530b, 532b, respectively. Next, the producer-facing component 341a sends the event stream to the consumer-facing component 341b. The consumer-facing component 341b transmits a copy of the event stream (the version as modified by the producer-facing component 341a) to the consumer 330b. While the events 520c, 522c, 530c, 532c are unmodified copies of the events 520b, 522b, 530b, 532b, respectively, the placeholder events 510q, 512q are copies of the placeholder events 510p, 512p, respectively. No copies of the events 510a, 512a are included in the version of the event stream that is transmitted to the consumer 330b.

In addition, the producer-facing component 341a causes the event 510b (which is an unmodified copy of the event 510a) and the event 512b (which is an unmodified copy of the event 512a) to be stored in the event repository 324. In some implementations, the constraint engine 340 may first verify that the event repository 324 does not violate the particular constraint before causing the events to be stored in the event repository 324.

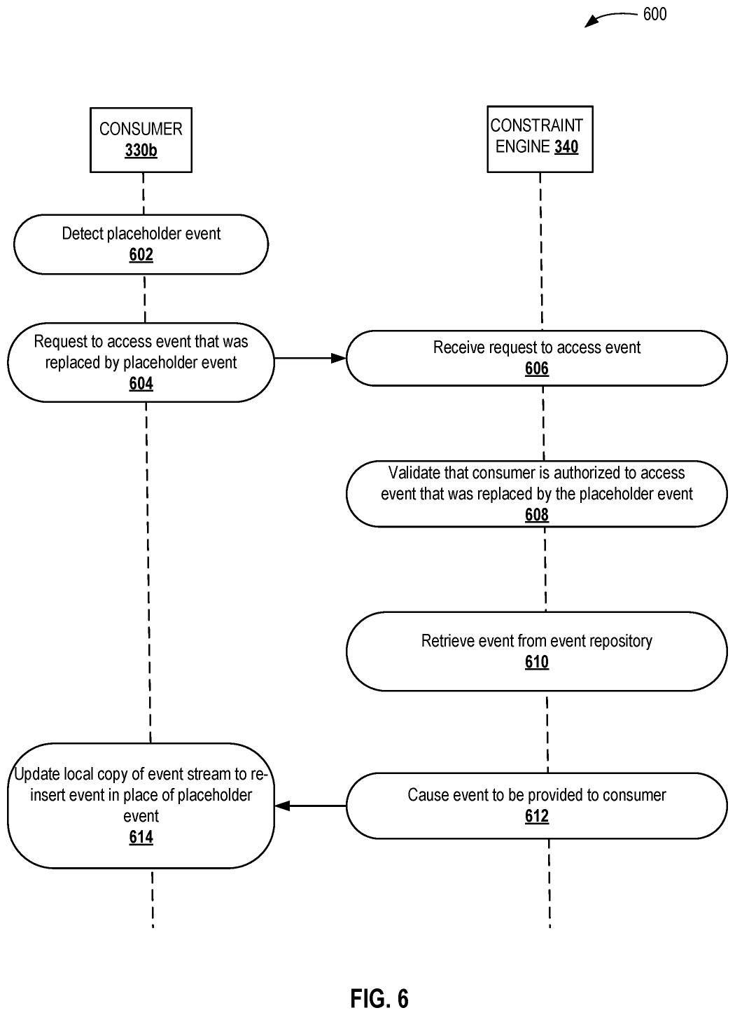

Turning next to FIG. 6, an example process 600 that may be performed in an event-driven architecture is shown, in which the consumer 330b accesses a copy of an event (e.g., the event 510a and/or the event 512a shown in FIG. 5B) that was replaced by a placeholder event in an event stream. While the example process 600 is provided for illustrative purposes, other variations of processes for accessing copies of events replaced by placeholder events may also be applied. For example, some variations may include additional actions not depicted in the example process 600 or may omit actions that are depicted in the example process 600. Furthermore, some of the actions shown in the example process 600 may be performed in an order other than the order shown in the example process 600.

The example process 600 may begin at block 602 when the consumer 330b detects a placeholder event in an event stream received at the consumer 330b from the constraint engine 340. The detection action may take various forms. For example, the consumer 330b may, upon attempting to access a particular type of data found in unmodified events included in the event stream, detect that the particular type of data is not included in the placeholder event. In another example, the consumer 330b may detect that a type of data not found in unmodified events in the event stream is included in the placeholder event (e.g., event location metadata), thereby identifying the event as a placeholder event. Other approaches for detecting the placeholder event may also be used.

Block 604 involves the consumer 330b transmitting a request to the constraint engine 340 (e.g., the customer-facing component 341b shown in FIG. 5B) to access the event that was replaced by the placeholder event in the event stream. The request may include, for example, event location metadata found in the placeholder event to identify which event the consumer 330b is requesting and where the event is stored.

Block 606 involves the constraint engine 340 receiving the request to access the event.

Block 608 involves the constraint engine 340 validating that the consumer 330b is authorized to access the event that was replaced by the placeholder event in the event stream. This validation action may take various forms. For example, the constraint engine 340 may identify the particular constraint(s) that govern the event and verify that none of the particular constraints would be violated if the event were to be sent to the consumer 330b (e.g., by verifying that a location of the consumer 330b does not violate the particular constraint(s) or that an authorization level associated with the consumer 330b is sufficient for the consumer 330b to receive the event without violating the constraint).

Block 610 involves the constraint engine 340 retrieving the event from the event repository where the event is stored in response to validating that the consumer 330b is authorized to access the event. The manner in which the retrieval of the event is accomplished may take various forms. For example, the constraint engine 340 may submit a query to the event repository (e.g., in Structured Query Language (SQL) or another query language through which queries may be submitted to the event repository. The query may include, for example, event location metadata included in the placeholder event and in the request that the consumer 330b transmitted to the constraint engine 340 in block 604.

At block 612, after the event has been retrieved from the event repository successfully, the constraint engine 340 causes the event to be provided to the consumer 330b (e.g., by transmitting the event to the consumer 330b over a secure connection). The manner in which the event is provided to the consumer 330b may take various other forms.

Block 614 involves the consumer 330b updating a local copy of the event stream to re-insert the event in place of the placeholder event.

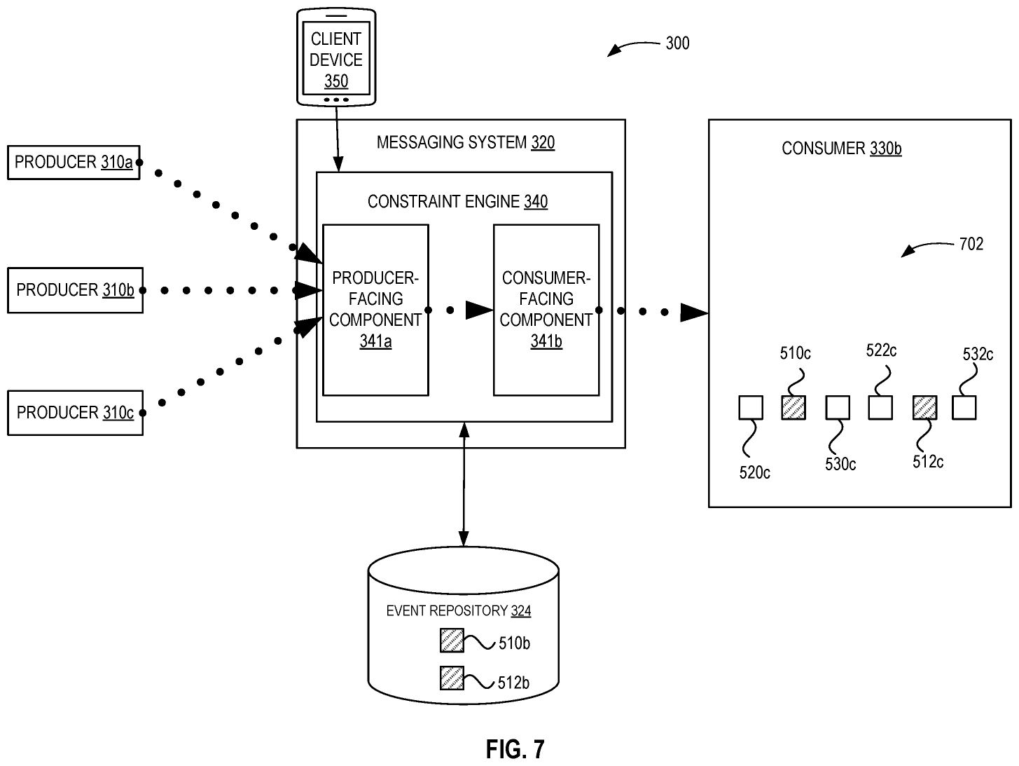

Turning next to FIG. 7, an example scenario in which the computing platform 300 performs processes described herein (e.g., the example process 600 shown in FIG. 6) is provided to show how a local copy of an event stream at the consumer 330b will appear after placeholder events are replaced with unmodified copies of events.

Like FIG. 5B, FIG. 7 depicts the computing platform 300 and many elements included therein (e.g., the producers 310a-c, the event repository 324, the client device 350, the constraint engine 340, the producer-facing component 341a, the consumer-facing component 341b, and the consumer 330b). However, FIG. 7 also depicts the state of a local copy 702 of the event stream that was transmitted to the consumer 330b (e.g., as described with respect to FIG. 5B) after the example process 600 has been applied to the placeholder events 510q, 512q depicted in FIG. 5B.

As shown, the local copy 702 of the event stream still includes the events 520c, 530c, 522c, 532c shown in FIG. 5B. However, in place of the placeholder events 510q, 512q shown in FIG. 5B, the local copy 702 of the event stream has been updated to include events 510c, 512c, respectively. The events 510c, 512c are unmodified copies of the events 510b, 512b, respectively (which are, in turn, unmodified copies of the events 510a, 512a shown in FIG. 5B, respectively). The result is that the constraint engine 340 has successfully facilitated the event stream such that (i) the constraints in the set of constraints have not been violated, (ii) the continuity of the event stream has not been compromised, and (iii) copies of constrained events have been made available upon request to consumers who are permitted to receive unmodified copies of the constrained events without violating any applicable constraints.

Turning now to FIG. 8, a simplified block diagram is provided to illustrate some structural components that may be included in an example computing platform 800 that may be configured to perform some or all of the functions discussed herein for constraint enforcement in event streams in accordance with the present disclosure. At a high level, the computing platform 800 may generally comprise any one or more computer systems (e.g., one or more servers) that collectively include one or more processors 802, data storage 804, and one or more communication interfaces 806, all of which may be communicatively linked by a communication link 808 that may take the form of a system bus, a communication network such as a public, private, or hybrid cloud, or some other connection mechanism. Each of these components may take various forms.

For instance, the one or more processors 802 may comprise one or more processor components, such as one or more central processing units (CPUs), graphics processing units (GPUs), application-specific integrated circuits (ASICs), digital signal processor (DSPs), and/or programmable logic devices such as a field programmable gate arrays (FPGAs), among other possible types of processing components. In line with the discussion above, it should also be understood that the one or more processors 802 could comprise processing components that are distributed across a plurality of physical computing devices connected via a network, such as a computing cluster of a public, private, or hybrid cloud.

In turn, data storage 804 may comprise one or more non-transitory computer-readable storage mediums, examples of which may include volatile storage mediums such as random-access memory, registers, cache, etc. and non-volatile storage mediums such as read-only memory, a hard-disk drive, a solid-state drive, flash memory, an optical-storage device, etc. In line with the discussion above, it should also be understood that data storage 804 may comprise computer-readable storage mediums that are distributed across a plurality of physical computing devices connected via a network, such as a storage cluster of a public, private, or hybrid cloud that operates according to technologies such as AWS for Elastic Compute Cloud, Simple Storage Service, etc.

As shown in FIG. 8, data storage 804 may be capable of storing both (i) program instructions that are executable by processor 802 such that the computing platform 800 is configured to perform any of the various functions disclosed herein (including but not limited to any the functions described above with reference to FIGS. 3-7), and (ii) data that may be received, derived, or otherwise stored by the computing platform 800.

The one or more communication interfaces 806 may comprise one or more interfaces that facilitate communication between computing platform 800 and other systems or devices, where each such interface may be wired and/or wireless and may communicate according to any of various communication protocols, examples of which may include Ethernet, Wi-Fi, serial bus (e.g., Universal Serial Bus (USB) or Firewire), cellular network, and/or short-range wireless protocols, among other possibilities.

Although not shown, the computing platform 800 may additionally include or have an interface for connecting to one or more user-interface components that facilitate user interaction with the computing platform 800, such as a keyboard, a mouse, a trackpad, a display screen, a touch-sensitive interface, a stylus, a virtual-reality headset, and/or one or more speaker components, among other possibilities.

It should be understood that computing platform 800 is one example of a computing platform that may be used with the examples described herein. Numerous other arrangements are possible and contemplated herein. For instance, other computing systems may include additional components not pictured and/or more or less of the pictured components.

### CONCLUSION

This disclosure makes reference to the accompanying figures and several examples of the disclosed innovations that have been described above. One of ordinary skill in the art should understand that such references are for the purpose of explanation only and are therefore not meant to be limiting. Part or all of the disclosed systems, devices, and methods may be rearranged, combined, added to, and/or removed in a variety of manners without departing from the true scope and sprit of the present invention, which will be defined by the claims.

Further, to the extent that examples described herein involve operations performed or initiated by actors, such as “humans,” “curators,” “users” or other entities, this is for purposes of example and explanation only. The claims should not be construed as requiring action by such actors unless explicitly recited in the claim language.

We claim:

1. A computing system comprising:
a network interface for communicating over at least one data network;
at least one processor;
at least one non-transitory computer-readable medium; and
program instructions stored on the at least one non-transitory computer-readable medium that are executable by the at least one processor such that the computing system is configured to:
receive an event stream produced by at least one event producer;
evaluate each respective event in the event stream against a set of one or more constraints;
based on the evaluation, determine that a given event in the event stream is governed by a given constraint in the set of one or more constraints;
after determining that the given event is governed by the given constraint:
cause the event to be replaced by a corresponding placeholder event within the event stream, wherein the placeholder event omits at least a portion of data included within the given event; and
cause the given event to be stored in an event repository that complies with the given constraint.

2. The computing system of claim 1, further comprising program instructions stored on the at least one non-transitory computer-readable medium that are executable by the at least one processor such that the computing system is configured to:
receive, from a consumer that has subscribed to the event stream, a request for the given event;
validate that the consumer is authorized to access the given event;
retrieve the given event from the data repository; and
transmit the given event to the consumer in response to the request.

3. The computing system of claim 2, wherein the program instructions that are executable by the at least one processor such that the computing system is configured to validate that the consumer is authorized to access the given event comprise program instructions that are executable by the at least one processor such that the computing system is configured to:
identify a location where the consumer is located;
compare the location to a triggering condition included in the given constraint; and
based on the comparison, determine that transmitting the given event to the consumer would not violate the constraint.

4. The computing system of claim 2, program instructions that are executable by the at least one processor such that the computing system is configured to validate that the consumer is authorized to access the given event comprise program instructions that are executable by the at least one processor such that the computing system is configured to:
identify an information technology (IT) protocol that is enforced upon the consumer;
compare the IT protocol to a triggering condition included in the given constraint; and
based on the comparison, determine that transmitting the given event to the consumer would not violate the constraint.

5. The computing system of claim 1, wherein the placeholder event:
omits at least a portion of an event payload included in the given event; and
includes data that identifies that the given event is stored in the data repository.

6. The computing system of claim 1, further comprising program instructions stored on the at least one non-transitory computer-readable medium that are executable by the at least one processor such that the computing system is configured to, prior to causing the given event to be stored in the event repository:
identify a location where the event repository is located;
compare the location of the event repository to a triggering condition included in the given constraint; and
based on the comparison, determine that storing the given event in the event repository would not violate the given constraint.

7. The computing system of claim 1, wherein the at least one event producer comprises a point-of-sale system that produced the given event in response to a purchase made via the point-of-sale system.

8. A non-transitory computer-readable medium, wherein the non-transitory computer-readable medium is provisioned with program instructions that, when executed by at least one processor, cause a computing system to:
receive an event stream produced by at least one event producer;
evaluate each respective event in the event stream against a set of one or more constraints;
based on the evaluation, determine that a given event in the event stream is governed by a given constraint in the set of one or more constraints;
after determining that the given event is governed by the given constraint:
cause the event to be replaced by a corresponding placeholder event within the event stream, wherein the placeholder event omits at least a portion of data included within the given event; and
cause the given event to be stored in an event repository that complies with the given constraint.

9. The non-transitory computer-readable medium of claim 8, further provisioned with program instructions that, when executed by the at least one processor, cause the computing system to:
receive, from a consumer that has subscribed to the event stream, a request for the given event;
validate that the consumer is authorized to access the given event;
retrieve the given event from the data repository; and
transmit the given event to the consumer in response to the request.

10. The non-transitory computer-readable medium of claim 9, wherein the program instructions that, when executed by at least one processor, cause the computing system to validate that the consumer is authorized to access the given event comprise program instructions that, when executed by at least one processor, cause a computing system to:
identify a location where the consumer is located;
compare the location to a triggering condition included in the given constraint; and
based on the comparison, determine that transmitting the given event to the consumer would not violate the constraint.

11. The non-transitory computer-readable medium of claim 9, program instructions that, when executed by at least one processor, cause the computing system to validate that the consumer is authorized to access the given event comprise program instructions that, when executed by at least one processor, cause a computing system to:
identify an information technology (IT) protocol that is enforced upon the consumer;
compare the IT protocol to a triggering condition included in the given constraint; and
based on the comparison, determine that transmitting the given event to the consumer would not violate the constraint.

12. The non-transitory computer-readable medium of claim 8, wherein the placeholder event:
omits at least a portion of an event payload included in the given event; and
includes data that identifies that the given event is stored in the data repository.

13. The non-transitory computer-readable medium of claim 8, further provisioned with program instructions that, when executed by the at least one processor, cause the computing system to, prior to causing the given event to be stored in the event repository:
identify a location where the event repository is located;
compare the location of the event repository to a triggering condition included in the given constraint; and
based on the comparison, determine that storing the given event in the event repository would not violate the given constraint.

14. The non-transitory computer-readable medium of claim 8, wherein the at least one event producer comprises a point-of-sale system that produced the given event in response to a purchase made via the point-of-sale system.

15. A method carried out by a computing system, the method comprising:
receiving an event stream produced by at least one event producer;
evaluating each respective event in the event stream against a set of one or more constraints;
based on the evaluation, determining that a given event in the event stream is governed by a given constraint in the set of one or more constraints;
after determining that the given event is governed by the given constraint:
causing the event to be replaced by a corresponding placeholder event within the event stream, wherein the placeholder event omits at least a portion of data included within the given event; and
causing the given event to be stored in an event repository that complies with the given constraint.

16. The method of claim 15, further comprising:
receiving, from a consumer that has subscribed to the event stream, a request for the given event;
validating that the consumer is authorized to access the given event;
retrieving the given event from the data repository; and
transmitting the given event to the consumer in response to the request.

17. The method of claim 16, wherein validating that the consumer is authorized to access the given event comprises:
identifying a location where the consumer is located;
comparing the location to a triggering condition included in the given constraint; and
based on the comparison, determining that transmitting the given event to the consumer would not violate the constraint.

18. The method of claim 16, wherein validating that the consumer is authorized to access the given event comprises:
identifying an information technology (IT) protocol that is enforced upon the consumer;
comparing the IT protocol to a triggering condition included in the given constraint; and
based on the comparison, determining that transmitting the given event to the consumer would not violate the constraint.

19. The method of claim 15, wherein the placeholder event:
omits at least a portion of an event payload included in the given event; and
includes data that identifies that the given event is stored in the data repository.

20. The method of claim 15, further comprising, prior to causing the given event to be stored in the event repository:
identifying a location where the event repository is located;
comparing the location of the event repository to a triggering condition included in the given constraint; and
based on the comparison, determining that storing the given event in the event repository would not violate the given constraint.
